(19) United States
(12) Patent Application Publication
(10) Pub. No.: US 2020/0073893 A1
(43) Pub. Date: Mar. 5, 2020

(54) Method, Apparatus And System For Automated Setup of Co-Users' Meta Profiles

(71) Applicant: KONINKLIJKE PHILIPS N.V., Eindhoven (NL)

(72) Inventors: Elise Claude Valentine TALGORN, Eindhoven (NL); Lucas Jacobus Franciscus GEURTS, Noord Brabant (NL); Vincentius Paulus BUIL, Veldhoven (NL)

(21) Appl. No.: 16/556,301

(22) Filed: Aug. 30, 2019

(30) Foreign Application Priority Data
Sep. 5, 2018 (EP) 18192630.4

(51) Int. Cl. G06F 16/9035; G06F 16/9032; G06F 16/908; G06Q 50/00; H04W 4/80

(52) U.S. Cl. CPC G06F 16/9035; G06F 16/90332; H04W 4/80; G06Q 50/01; G06F 16/908

(57) ABSTRACT

Various embodiments relate to a method, apparatus and system for automatically setting up meta profiles of a co-user, the method including the steps of receiving basic information about the co-user, extracting and analyzing from a social media and online behavior module, detailed information about the co-user based on the basic information, creating the meta profile of the co-user, checking and completing the detailed information in the meta profile which is missing about the co-user; and translating the detailed information into an actionable to be used by a virtual assistant.

### CROSS-REFERENCE TO PRIOR APPLICATIONS

This application claims the benefit of European Patent Application No. 18192630.4, filed on 5 Sep. 2018. This application is hereby incorporated by reference herein.

### FIELD OF THE INVENTION

This disclosure relates generally to multi-user virtual assistants, and more specifically, but not exclusively, to a system for automatically setting up meta profiles of co-users.

### BACKGROUND OF THE INVENTION

Virtual assistants are beginning to play the role of coaches or guides for users to guide them through a medical condition, a lifestyle change (e.g., a change in diet), or a mind-related change (e.g., mindfulness training), etc.

During these time periods, the family and friends of the user may have an influence and interest in helping the user make it through these time periods. Generally, the family and friends are willing to help and may be interested in the results of tests that are being performed on the user.

### SUMMARY OF THE INVENTION

A brief summary of various embodiments is presented below. Embodiments address a method, apparatus and system for automatically setting up meta profiles of co-users.

A brief summary of various example embodiments is presented. Some simplifications and omissions may be made in the following summary, which is intended to highlight and introduce some aspects of the various example embodiments, but not to limit the scope of the invention.

Detailed descriptions of example embodiments adequate to allow those of ordinary skill in the art to make and use the inventive concepts will follow in later sections.

Various embodiments relate to a method for automatically setting up meta profiles of a co-user, the method including the steps of receiving basic information about the co-user, extracting and analyzing from a social media and online behavior module, detailed information about the co-user based on the basic information, creating the meta profile of the co-user, checking and completing the detailed information in the meta profile which is missing about the co-user and translating the detailed information into an actionable to be used by a virtual assistant.

In an embodiment of the present disclosure, the method for automatically setting up meta profiles of a co-user, the method further including the steps of checking a result of the actionable for effectiveness, improving the translation of the detailed information by machine learning algorithms and extracting additional information from the social media and online behavior module and requesting input from a main user.

In an embodiment of the present disclosure, the meta profile includes factual information and derived information.

In an embodiment of the present disclosure, the virtual assistant is activated by a Near Field Communication (“NFC”) activation card.

In an embodiment of the present disclosure, translating the detailed information into the actionable includes assessing the detailed information, converting the detailed information into an intensity score, and converting the intensity score into the actionable.

In an embodiment of the present disclosure, a level of information to be communicated to the co-user is determined by age, emotional level, cognitive level, and the detailed information from the social media and online behavior module.

In an embodiment of the present disclosure, a level of help that can be expected from a co-user can be determined by age, relation to a user, and the detailed information from the social media and online behavior module.

In an embodiment of the present disclosure, access to the detailed information from the social media and online behavior module requires consent from the co-user.

In an embodiment of the present disclosure, a level of communication for a co-user can be determined by mail and chat discussions between the main user and a co-user.

In an embodiment of the present disclosure, a level of language for a co-user can be determined by age, education and social media.

In an embodiment of the present disclosure, a type of communication for a co-user can be determined by literacy of the co-user extracted from social media, mail and chat.

In an embodiment of the present disclosure, an approach to a delicate topic for a co-user can be determined by emotional response of the co-user extracted from social media, mail and chat.

Various embodiments relate to a non-transitory computer readable medium configured for automatically setting up a meta profile of a co-user, the device including a memory; and a processor configured to receive basic information about the co-user, extract and analyzing from a social media and online behavior module, detailed information about the co-user based on the basic information, create the meta profile of the co-user, check and complete the detailed information in the meta profile which is missing about the co-user and translate the detailed information into an actionable to be used by a virtual assistant.

In an embodiment of the present disclosure, the non-transitory computer readable medium, the processor further configured to check a result of the actionable for effectiveness, improve the translation of the detailed information by machine learning algorithms and extracting additional information from the social media and online behavior module and request input from a main user.

In an embodiment of the present disclosure, the meta profile includes factual information and derived information.

In an embodiment of the present disclosure, the virtual assistant is activated by a Near Field Communication (“NFC”) activation card.

In an embodiment of the present disclosure, translating the detailed information into the actionable includes assessing the detailed information, converting the detailed information into an intensity score and converting the intensity score into the actionable.

In an embodiment of the present disclosure, a level of information that can be communicated to the co-user can be determined by age, emotional level, cognitive level and the detailed information from the social media and online behavior module.

In an embodiment of the present disclosure, a level of help that can be expected from a co-user can be determined by age, relation to a user and the detailed information from the social media and online behavior module.

In an embodiment of the present disclosure, access to the detailed information from the social media and online behavior module requires consent from the co-user.

In an embodiment of the present disclosure, a level of communication for a co-user can be determined by mail and chat discussions between the main user and a co-user.

In an embodiment of the present disclosure, a level of language for a co-user can be determined by age, education and social media.

In an embodiment of the present disclosure, a type of communication for a co-user can be determined by literacy of the co-user extracted from social media, mail and chat.

In an embodiment of the present disclosure, an approach to a delicate topic for a co-user can be determined by emotional response of the co-user extracted from social media, mail and chat.

Various embodiments relate to a system for automatically setting up meta profiles of a co-user, the system including the steps of receiving basic information about the co-user, extracting and analyzing from a social media and online behavior module, detailed information about the co-user based on the basic information, creating the meta profile of the co-user, checking and completing the detailed information in the meta profile which is missing about the co-user and translating the detailed information into an actionable to be used by a virtual assistant.

In an embodiment of the present disclosure, the system for automatically setting up meta profiles of a co-user, the method further including the steps of checking a result of the actionable for effectiveness, improving the translation of the detailed information by machine learning algorithms and extracting additional information from the social media and online behavior module and requesting input from a main user.

In an embodiment of the present disclosure, the meta profile includes factual information and derived information.

In an embodiment of the present disclosure, the virtual assistant is activated by a Near Field Communication (“NFC”) activation card.

In an embodiment of the present disclosure, translating the detailed information into the actionable includes assessing the detailed information, converting the detailed information into an intensity score and converting the intensity score into the actionable.

In an embodiment of the present disclosure, a level of information that can be communicated to the co-user can be determined by age, emotional level, cognitive level and the detailed information from the social media and online behavior module.

In an embodiment of the present disclosure, a level of help that can be expected from a co-user can be determined by age, relation to a user and the detailed information from the social media and online behavior module.

In an embodiment of the present disclosure, access to the detailed information from the social media and online behavior module requires consent from the co-user.

In an embodiment of the present disclosure, a level of communication for a co-user can be determined by mail and chat discussions between the main user and a co-user.

In an embodiment of the present disclosure, a level of language for a co-user can be determined by age, education and social media.

In an embodiment of the present disclosure, a type of communication for a co-user can be determined by literacy of the co-user extracted from social media, mail and chat.

In an embodiment of the present disclosure, an approach to a delicate topic for a co-user can be determined by emotional response of the co-user extracted from social media, mail and chat.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate example embodiments of concepts found in the claims and explain various principles and advantages of those embodiments.

These and other more detailed and specific features are more fully disclosed in the following specification, reference being had to the accompanying drawings, in which:

FIG. 1 illustrates a block diagram of a system for automating setup of co-users' profiles of the current embodiment;

FIG. 2 illustrates a flow diagram of the method for automating setup of co-users' profiles of the current embodiment; and

FIG. 3 illustrates a block diagram of a real-time data processing system of the current embodiment.

### DETAILED DESCRIPTION OF EMBODIMENTS

It should be understood that the figures are merely schematic and are not drawn to scale. It should also be understood that the same reference numerals are used throughout the figures to indicate the same or similar parts.

The descriptions and drawings illustrate the principles of various example embodiments. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor to furthering the art and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. Descriptors such as “first,” “second,” “third,” etc., are not meant to limit the order of elements discussed, are used to distinguish one element from the next, and are generally interchangeable.

The method, apparatus, and system for automatically setting up meta profiles of co-users will collect input about close relatives of the user or other co-users the user selects, and convert these inputs into actionable for a virtual assistant to encourage the co-users to support the user, provide the co-users with information about events, journeys, and physical and emotional state of the user, support emotionally the co-users, facilitate discussion between the user and the co-users.

For example, if the user is going through a disease, it may be a stressful time for the user and the co-users, and this system may advise the co-users how to help the user, but also guide them by informing and reassuring.

Multi-user applications, such as those enabling multiple gamers to be signed in and use the console at the same time in a single interactive session and multi-user systems such as enabling several users to use a single tablet device, use an administrator user and different rights and access permissions are set for the co-users.

Virtual assistants, such as Google Home or Amazon Echo, can also support several different accounts on the same device and identify the different voices of people living in the same home. The addition of multi-user support means that Google Home can tailor responses for each person and use data from each account when interacting with different users.

In those systems, the various users' settings are manually completed by the administrator or the co-users. In some cases, however, for example in an enterprise application, the co-users' data may already be present in the enterprise system and are uploaded automatically in the application (e.g., corporate grade); depending on those users' data, different levels of granting will be automatically set-up (e.g., access to a folder only for a certain corporate grade).

In the case of multi-user virtual assistant applications, the information needed may not only be factual (e.g., age, gender, literacy), but may also be subjective (e.g., emotional balance) and based on the input of the user (e.g., willingness to share certain information with certain co-users, or to ask for help from certain co-users).

The system may use the personal settings of the co-users (e.g., identity, voice, agenda, age, literacy, level of understanding, emotional response, level of confidentiality desired by the main user, etc.) to identify the co-users in a discussion, determine which information to gather from them, determine which type and detail of information to deliver to them and in which way to deliver the information.

For the system to accomplish these goals, customized meta-profiles for each co-user are required. For the main user to manually set up these profiles would be time consuming and the time invested by the user should be minimal in order to keep their engagement high, hence it is crucial that the set-up of the various detailed profiles is performed quickly and automatically.

Personal information may be retrieved from online sources (e.g., social media). Part of this information may be checked or corrected by the user, especially subjective information. The quantity of information that may be handled by the system has to be maximized and the part that must be interfaced to the user has to be minimized.

The functions required to be performed by the user may be performed by an administrator, for example, setting up the system adding co-users and verifying data.

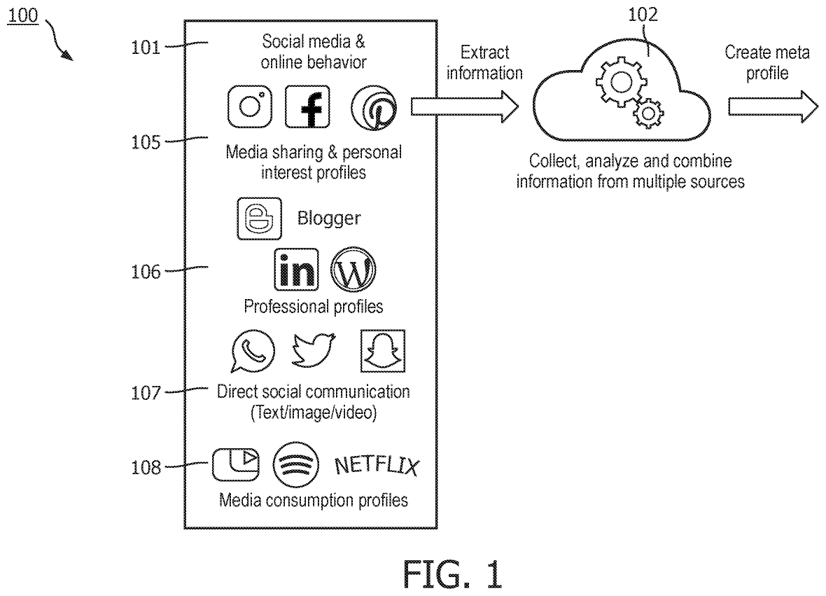

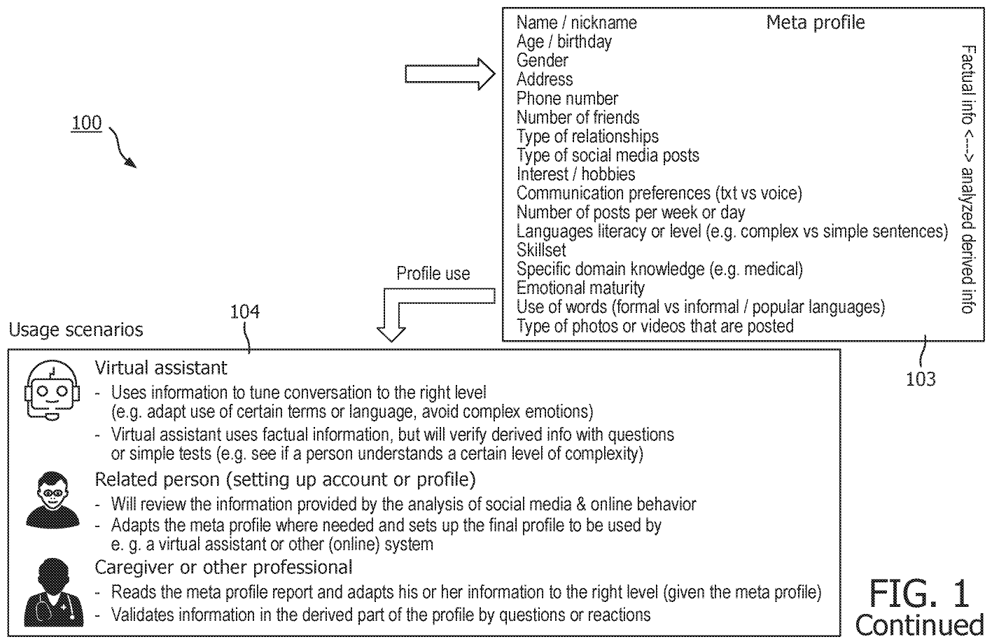

FIG. 1 illustrates a block diagram of a system 100 for automating setup of co-users' profiles of the current embodiment.

The system 100 may create co-users' meta profiles based on multiple sources that may be used by various people or a virtual assistant, to setup effective communication between the system 100 and the users.

The system will obtain a maximal part of the information needed to create the meta profiles from online data and process that online data in order to minimize the checking of this information and completing the missing information by the main user.

The system 100 may extract information from a social media and online behavior module 101. The social media and online behavior module 101 may extract information from, for example, media sharing and personal interest profile applications 105 such as Instagram, Facebook, and Pinterest, from professional profile applications 106 such as Blogger, LinkedIn and WordPress, from direct social communication applications 107 such as WhatsApp, Twitter and Snapchat, and from media consumption profile applications 108 such as YouTube, Spotify and Netflix.

The system 100 may use a processing module 102 to process, analyze, and combine the extracted information from multiple sources.

The system 100 may create meta profiles 103 of the co-users. The meta profiles 103 may include information such as name/nickname, age/birth, gender, address, telephone number, number of friends, type of relationships, types of social media posts, interests/hobbies, communication preferences (text messages v. voice calls), number of posts per week or day, language literacy or level (e.g., complex v. simple sentences), skillset, special domain knowledge (e.g., medical), emotional maturity, use of words (formal v. informal or popular language), type of photos or videos that are posted, etc. The meta profiles 103 may be a combination of factual information and analyzed derived information from the processing module 102.

The system 100 may use the meta profiles 103 in different usage scenarios 104. An example of a usage scenario 104 is a virtual assistant (e.g., on a tablet, smartphone or wearable device which may use a conversational interface such as a chatbot) which may use the information to tune a conversation to the correct level (e.g., adapt use of certain terms or language, avoid complex emotions, etc.) or may use the factual information but may verify derived information with questions or simple tests (e.g., determine if a user understands a certain level of complexity).

Another example of a usage scenario 104 is a related user, who may review the information provided by the analysis of the social media and online behavior module 101 or may adapt the meta profiles 103 where needed and set up the final profile to be used by a virtual assistant or other system.

Another example of a usage scenario 104 is a caregiver, administrator or other professional who may read the meta profile 103 and adapt the information as it pertains to them or may validate information in the derived part of the meta profile 103 by questions or reactions.

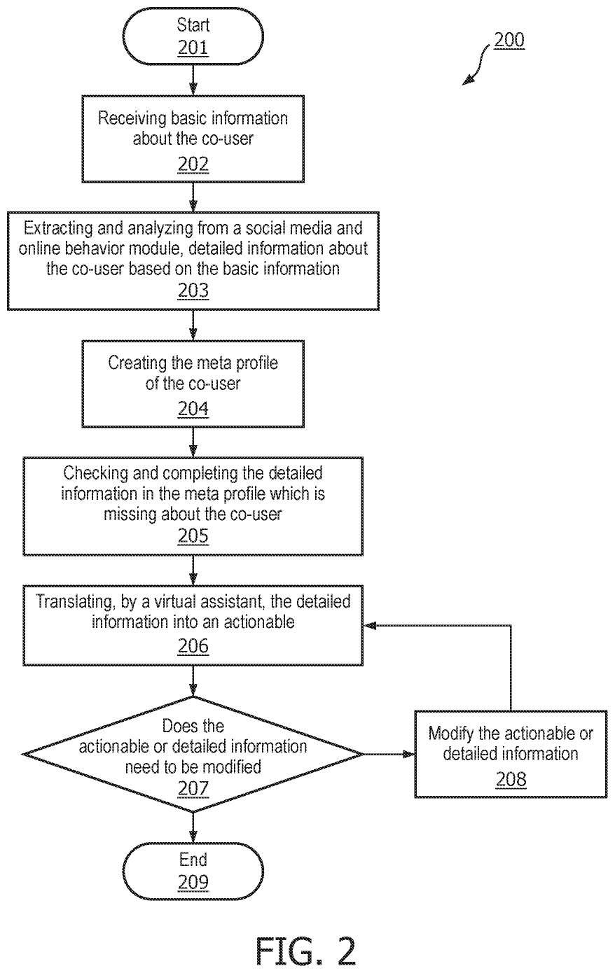

FIG. 2 illustrates a flow diagram of the method for automatically setting up co-users' meta profiles of the current embodiment.

FIG. 2 illustrates a method 200 for automatically setting up co-users' meta profiles. The method 200 begins at step 201.

The method 200 then proceeds to step 202 which receives basic information about the co-user.

The method 200 then proceeds to step 203 which extracts and analyzes from a social media and online behavior module, detailed information about the co-user based on the basic information.

The method 200 then proceeds to step 204 which creates the meta profile of the co-user.

The method 200 then proceeds to step 205 which checks and completes the detailed information in the meta profile which is missing about the co-user.

The method 200 then proceeds to step 206 which translates, by a virtual assistant, the detailed information into an actionable.

The method 200 then determines whether the actionable or the detailed information needs to be modified. If no, the method 200 proceeds to step at step 209.

If yes, the method 200 proceeds to step 208 which modifies the actionable or detailed information. The method 200 then proceeds to step 206 to translate, by a virtual assistant, the detailed information into an actionable.

An example of this system would be the system being a virtual assistant application which guides a patient (i.e., a user) and his family and friends (i.e., co-users) through a cancer journey.

For example, after the user is diagnosed with cancer, the doctor may advise the patient to use the virtual assistant application and to activate it for family and friends.

When the user arrives at home, the user may introduce the virtual assistant application to family and friends and provide them with an NFC activation card.

The NFC activation card may activate the virtual assistant application on a mobile device and may contain the respective meta profiles of the family and friends. The family and friends may activate and access the virtual assistant system by scanning the NFC activation card with their mobile device.

The virtual assistant application may be partially set-up by the patient or administrator (e.g., for the user's daughter, choosing to hide difficult information such as related to death), and the virtual assistant application may also automatically adapt language complexity to that of a young female. The virtual assistant application, for his ex-wife, may choose to highlight factual information about his expected physical condition and financial information. The daughter and the ex-wife will finalize their personalized set-up and as the virtual assistant application knows about the individual characters and emotions, the virtual assistant application is able to address individual needs as well as to mediate the discussion between the family members.

Because the settings may be personal and the co-users may want them to be treated as private data, NFC is used in order to provide secure communication by promoting the transfer of data through safe channels as well as the encryption of sensitive information.

Access to the application may be through a physical card containing a NFC chip, or via device-to-device NFC transfer (and possibly the activation may be performed at a later period in time when the co-user is alone). Alternatively, access via cloud-based links may be used.

The main user and/or administrator may grant access to content of applications used by the co-user to the virtual assistant application when activating.

The following are alternative embodiments which include a list of information which the virtual assistant acquires from the source, which is a list of where the information may be found. The virtual assistant may then convert the information into an actionable, which is a list of actions that the virtual assistant may use the information for and if information is missing or incorrect, the virtual assistant may require additional input from the main user, the administrator and/or the co-user.

In an alternative embodiment, the virtual assistant may acquire the name or nickname of the main user from the main user and the virtual assistant uses this to definitively determine the co-user based on a general location and online relationship to the main user.

In an alternative embodiment, the virtual assistant may acquire the telephone number of the main user from the main user or an online profile (e.g., LinkedIn or a medical record) which may be checked by the main user, co-user or other administrator and the virtual assistant uses this to access the content of chatting application discussions between the user and the co-user(s), in order to analyze and mediate the discussion, access the digital agenda of the co-user in order to suggest to the co-user to meet or help the main user, access to the location of co-user in order to suggest to the co-user to meet or help the main user and to identify the preferred communication media of the co-user (text, voice, etc.).

In an alternative embodiment, the virtual assistant may acquire the e-mail address of the main user from the main user or an online profile which may be checked by the main user, co-user or other administrator and the virtual assistant uses this to access mail discussions between the user and the co-users in order to analyze and mediate the discussion.

In an alternative embodiment, the virtual assistant may acquire the age of the co-user from the social media or online profile which may be checked by the main user, co-user or other administrator and the virtual assistant uses this to determine the level of information that can be communicated to the co-user (e.g., about disease gravity, death risks, complexity of medical explanations, feelings of main user that can be shared) and level of help that can be expected from the co-user to the user (emotional support, physical support, financial support).

In an alternative embodiment, the virtual assistant may acquire the status of the relationship of the co-user to the user from social media which may be checked by the main user, co-user or other administrator and the virtual assistant uses this to determine the level of help that can be expected from the co-user to the user (emotional support, physical support, financial support).

In an alternative embodiment, the virtual assistant may acquire the literacy level of the co-user by a lexical and syntax analysis of messages on social media and the virtual assistant uses this to determine appropriate lexicon and syntax to talk to the co-user (for the assistant directly, or as a recommendation from the assistant to the user) and use other appropriate communication channels (pictures, videos).

In an alternative embodiment, the virtual assistant may acquire the cognitive level of the co-user from an analysis of messages (detailed, complexity of content) and shared articles on social media and the virtual assistant uses this to determine the level of information (detail, complexity) which may be understood for the co-user (e.g., about disease and treatment).

In an alternative embodiment, the virtual assistant may acquire the emotional response of the co-user from an analysis of emotional response (level of personal sharing, empathic reactivity to other's emotions) on social medial and emotional tenure of shared links which may be checked by the main user, co-user or other administrator and the virtual assistant uses this to determine how to approach a delicate topic (e.g., frankly for an emotionally strong and action-driven person, progressively for a sensitive person, in presence of other people for a person who likes to share, alone for a person who takes their time to process information), create a list of sensitive topics and determine the level of emotional support that can be expected from the co-user to the user.

In an alternative embodiment, the virtual assistant may acquire the social environment of the co-user by an analysis of the number of friends/contacts and type of relationships of the co-user, the number of likes and shared posts the co-user has received and given, online activity level and participation in real-life social events by social media invites and the virtual assistant uses this to determine friends of co-user who can be reached easily for support and detect isolation.

In an alternative embodiment, the virtual assistant may acquire interests of the co-user by an analysis of shared content (quantity, topics) on social media and the virtual assistant may use this to determine skill that can be useful to user (specific domain knowledge, practical skill, also professional skill) and determine discussion topics (e.g. of identified hobbies) for the assistant to build trust with the co-user to for the assistant to suggest in order to establish a discussion between the co-user and user.

Each actionable is the output of a separate algorithm component, including an assessment which is data input, converting the data input into an intensity score (1D or 2D per element), then converting the intensity score into an actionable based on rule system.

For example, creating an actionable based on language level is now described.

The first step is assessment, which is data input including age (directly from medical record or Facebook account data or profile set-up), level of education (directly from Facebook or Linkedin profile data on school), number of emoticons in social posts, length of sentences in social posts and length of words in social posts.

The second step is converting the data input into an intensity score, which scores the language level along age/academic level axis and emoticon/word and sentence length axis. For example, language level A is 1 if 5-10 years-old, language level A=2 if 10-15 years-old, language level A=3 if above 15 years-old and no/low academic education (<2 years), language level A=4 if above 15 years-old and middle academic education (2-5 years) and language level A=5 if above 15 years-old and high academic education (>5 years) or middle related education (2-5 years in e.g. medical field). Language level B defines average number of emoticons and number of words per sentence and average length of words.

The third step is converting the intensity score into an actionable. For example, if language level A=1 then use middle school lexica and grammatical structure, if language level A=2 then use high school lexica and grammatical structure, if language level A=3 then use general mass reading lexica and grammatical structure, if language level A=4 then use high-level reading lexica and grammatical structure and if language level A=5 then use high-level grammatical structure and specialized lexica.

Language level B defines the average number of emoticons and number of words per sentence and average length of words used by the system with a mirroring principle.

As another example, creating an actionable based on cognitive level is now described.

The first step is assessment which is data input including age (directly from medical record or Facebook account data or profile set-up), level of education (directly from Facebook or Linkedin profile data on school/indirectly from lexical analysis) and type of content shared

The second step is converting the data input into an intensity score. Score the cognitive level along age/academic level and complexity of content shared ranging from entertainment, news to specialized content.

The third step is converting intensity score into an actionable. Adapt the level of details (e.g., basic anatomy as described in children's book to level of detail similar to medical literature) to cognitive level score.

As another example, creating an actionable based on emotional level is now described.

The first step is assessment which is data input including type of content shared online, type of content reacted upon, and type of reaction on content

The second step is converting the data input into an intensity score. Score the emotional level with type of content shared and reacted upon and weight per total number of shared content.

For example, emotional level A=1 if content is functional (sport, technical), emotional level A=2 if content is medium emotional (humor, pets, movie trailers), emotional level A=3 if content is highly emotional (dramatic news, drama movies), emotional level B=1 if answer is a short sentence (<5 words) or 1-2 emoticons, emotional level B=2 if answer is a long sentence (>5 words) >3 emoticons.

The third step is converting the intensity score into an actionable. If emotional level A=1, then the system does not know how to approach sensitive content with the co-user and needs to ask to the main user input. If emotional level A=2, then the system can approach the co-user by announcing sensitive news progressively e.g. with conversation, delivering progressively the news, and probing the emotional reaction of the user at each step to adapt sharing the next news. If emotional level A=3, then the system can approach the user by announcing sensitive news by using similar stories e.g. short videos and interviews, then probe the reaction and possibly engage a conversation, if emotional level B=1, then the system should dispense the sensitive news sequentially and ask to the main user to check at each step on the user, if emotional level B=2, then the system can check itself on the user to ask them how affected they are about the news.

As another example, creating an actionable for social support is now described.

The first step is assessment which is data input including time spent on communication means and type of communication means, preferred time for use of communication means, reaction speed to the main user and reaction length of the main user.

The second step is to convert the data input into an intensity score. Classification of preferred communication means (Whatsapp, email, phone call) and time of use (all day long, only evening). Classify co-users amongst them per order of reaction speed and length of the main user.

The third step is to convert the intensity score into an actionable. When the main user needs support (e.g. distress is detected physiologically or from text input), select available co-users in terms of preferred time of use. Within the selected co-users, select the co-user which has the highest reaction speed and length. Reach out to this user by using their favorite communication mean and trigger to engage communication with main user.

By using machine learning algorithms and data gathering techniques, the embodiments described above are able to process the data gathered to determine means of communicating with users and co-user including the language level of the user, the cognitive level of the user, the emotional level of the user and the social support of the user. Virtual assistants in multi-user systems using these machine learning algorithms can optimize the actionable level by continuously checking the result of an actionable on a user (dialogue analysis, emotional response . . . ) and adapt the conversion of the input data into actionable.

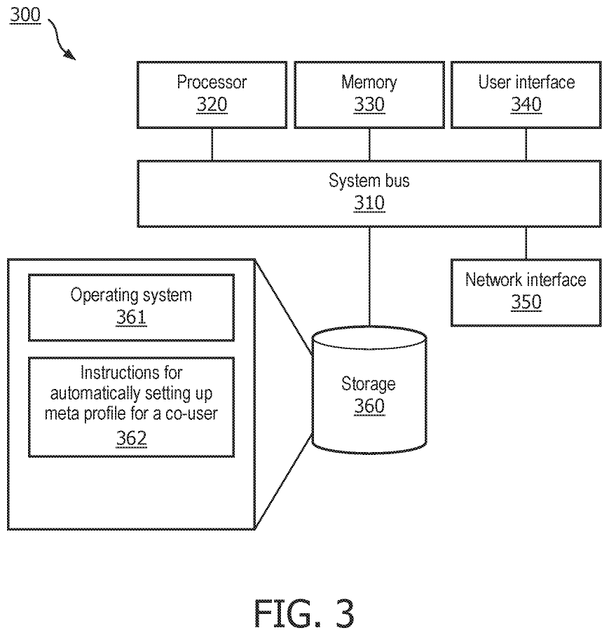

FIG. 3 illustrates a block diagram of a real-time data processing system of the current embodiment. As shown, the device 300 includes a processor 320, memory 330, user interface 340, network interface 350, and storage 360 interconnected via one or more system buses 310. It will be understood that FIG. 3 constitutes, in some respects, an abstraction and that the actual organization of the components of the device 300 may be more complex than illustrated.

The processor 320 may be any hardware device capable of executing instructions stored in memory 330 or storage 360 or otherwise processing data. As such, the processor may include a microprocessor, field programmable gate array (FPGA), application-specific integrated circuit (ASIC), or other similar devices.

The memory 330 may include various memories such as, for example L1, L2, or L3 cache or system memory. As such, the memory 330 may include static random access memory (SRAM), dynamic RAM (DRAM), flash memory, read only memory (ROM), or other similar memory devices.

The user interface 340 may include one or more devices for enabling communication with a user such as an administrator. For example, the user interface 340 may include a display, a mouse, and a keyboard for receiving user commands. In some embodiments, the user interface 340 may include a command line interface or graphical user interface that may be presented to a remote terminal via the network interface 350.

The network interface 350 may include one or more devices for enabling communication with other hardware devices. For example, the network interface 350 may include a network interface card (NIC) configured to communicate according to the Ethernet protocol. Additionally, the network interface 350 may implement a TCP/IP stack for communication according to the TCP/IP protocols. Various alternative or additional hardware or configurations for the network interface 350 will be apparent.

The storage 360 may include one or more machine-readable storage media such as read-only memory (ROM), random-access memory (RAM), magnetic disk storage media, optical storage media, flash-memory devices, or similar storage media. In various embodiments, the storage 360 may store instructions for execution by the processor 320 or data upon with the processor 320 may operate. For example, the storage 360 may store a base operating system 361 for controlling various basic operations of the hardware 300 and instructions for implementing automatically setting up a meta profile for a co-user 362.

It will be apparent that various information described as stored in the storage 360 may be additionally or alternatively stored in the memory 330. In this respect, the memory 330 may also be considered to constitute a “storage device” and the storage 360 may be considered a “memory.” Various other arrangements will be apparent. Further, the memory 330 and storage 360 may both be considered “non-transitory machine-readable media.” As used herein, the term “non-transitory” will be understood to exclude transitory signals but to include all forms of storage, including both volatile and non-volatile memories.

While the host device 300 is shown as including one of each described component, the various components may be duplicated in various embodiments. For example, the processor 320 may include multiple microprocessors that are configured to independently execute the methods described herein or are configured to perform steps or subroutines of the methods described herein such that the multiple processors cooperate to achieve the functionality described herein. Further, where the device 300 is implemented in a cloud computing system, the various hardware components may belong to separate physical systems. For example, the processor 320 may include a first processor in a first server and a second processor in a second server.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A non-transitory machine-readable storage medium may include any mechanism for storing information in a form readable by a machine, such as a personal or laptop computer, a server, or other computing device. Thus, a non-transitory machine-readable storage medium may include read-only memory (ROM), random-access memory (RAM), magnetic disk storage media, optical storage media, flash-memory devices, and similar storage media and excludes transitory signals.

It should be appreciated by those skilled in the art that any blocks and block diagrams herein represent conceptual views of illustrative circuitry embodying the principles of the invention. Implementation of particular blocks can vary while they can be implemented in the hardware or software domain without limiting the scope of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for automatically setting up meta profiles of a co-user, the method comprising the steps of:
receiving basic information about the co-user;
extracting and analyzing from a social media and online behavior module, detailed information about the co-user based on the basic information;
creating the meta profile of the co-user;
checking and completing the detailed information in the meta profile which is missing about the co-user; and
translating the detailed information into an actionable to be used by a virtual assistant.

2. The method for automatically setting up meta profiles of a co-user of claim 1, the method further comprising the steps of:
checking a result of the actionable for effectiveness;
improving the translation of the detailed information by machine learning algorithms and extracting additional information from the social media and online behavior module; and
requesting input from a main user.

3. The method for automatically setting up meta profiles of a co-user of claim 1, wherein the meta profile includes factual information and derived information.

4. The method for automatically setting up meta profiles of a co-user of claim 1, wherein the virtual assistant is activated by a Near Field Communication (“NFC”) activation card.

5. The method for automatically setting up meta profiles of a co-user of claim 1, wherein translating the detailed information into the actionable includes assessing the detailed information, converting the detailed information into an intensity score, and converting the intensity score into the actionable.

6. The method for automatically setting up meta profiles of a co-user of claim 1, wherein a level of information to be communicated to the co-user is determined by age, emotional level, cognitive level, and the detailed information from the social media and online behavior module.

7. The method for automatically setting up meta profiles of a co-user of claim 1, wherein a level of help that can be expected from a co-user can be determined by age, relation to a user, and the detailed information from the social media and online behavior module.

8. The method for automatically setting up meta profiles of a co-user of claim 1, wherein access to the detailed information from the social media and online behavior module requires consent from the co-user.

9. The method for automatically setting up meta profiles of a co-user of claim 1, wherein a level of communication for a co-user can be determined by mail and chat discussions between the main user and a co-user.

10. The method for automatically setting up meta profiles of a co-user of claim 1, wherein a level of language for a co-user can be determined by age, education and social media.

11. The method for automatically setting up meta profiles of a co-user of claim 1, wherein a type of communication for a co-user can be determined by literacy of the co-user extracted from social media, mail and chat.

12. The method for automatically setting up meta profiles of a co-user of claim 1, wherein an approach to a delicate topic for a co-user can be determined by emotional response of the co-user extracted from social media, mail and chat.

13. A system for automatically setting up meta profiles of a co-user, the system comprising the steps of:
receiving basic information about the co-user;
extracting and analyzing from a social media and online behavior module, detailed information about the co-user based on the basic information;
creating the meta profile of the co-user;
checking and completing the detailed information in the meta profile which is missing about the co-user; and
translating the detailed information into an actionable to be used by a virtual assistant.

14. The system for automatically setting up meta profiles of a co-user of claim 13, the method further comprising the steps of:
checking a result of the actionable for effectiveness;
improving the translation of the detailed information by machine learning algorithms and extracting additional information from the social media and online behavior module; and
requesting input from a main user.

15. The system for automatically setting up meta profiles of a co-user of claim 13, wherein the meta profile includes factual information and derived information.

16. The system for automatically setting up meta profiles of a co-user of claim 13, wherein the virtual assistant is activated by a Near Field Communication (“NFC”) activation card.

17. The system for automatically setting up meta profiles of a co-user of claim 13, wherein translating the detailed information into the actionable includes assessing the detailed information, converting the detailed information into an intensity score and converting the intensity score into the actionable.

18. The system for automatically setting up meta profiles of a co-user of claim 13, wherein a level of information that can be communicated to the co-user can be determined by age, emotional level, cognitive level and the detailed information from the social media and online behavior module.

19. The system for automatically setting up meta profiles of a co-user of claim 13, wherein access to the detailed information from the social media and online behavior module requires consent from the co-user.

20. A non-transitory computer readable medium configured for automatically setting up a meta profile of a co-user, the device comprising:
a memory; and
a processor configured to:
receive basic information about the co-user;
extract and analyzing from a social media and online behavior module, detailed information about the co-user based on the basic information;
create the meta profile of the co-user;
check and complete the detailed information in the meta profile which is missing about the co-user; and
translate the detailed information into an actionable to be used by a virtual assistant.
